(19) United States
(12) Patent Application Publication
(10) Pub. No.: US 2013/0252668 A1
(43) Pub. Date: Sep. 26, 2013

(54) CELLULAR WITH AN EXTENSION DISPLAY

(71) Applicants: Yi-Chuan Cheng, Changhua County (TW); Kuo-Ching Chiang, New Taipei City (TW)

(72) Inventors: Yi-Chuan Cheng, Changhua County (TW); Kuo-Ching Chiang, New Taipei City (TW)

(21) Appl. No.: 13/896,355

(22) Filed: May 17, 2013

Related U.S. Application Data
(63) Continuation-in-part of application No. 13/025,413, filed on Feb. 11, 2011.

(30) Foreign Application Priority Data
Feb. 12, 2010 (TW) 099104766

(51) Int. Cl. H04M 1/72

(52) U.S. Cl. CPC H04M 1/72
USPC 455/556.1

(57) ABSTRACT

A portable communication device includes a control unit, a main display and an extension display coupled to the control unit. The display area of the extension is larger than the one of the main display for displaying at least a part of the web page information or image (video) information. A driver is in responsive to the extension display interface to driver the extension display out of the cellular, wherein a finger of a user slide the extension slide bar on the main touch display, the driver being responsive the sliding to drive the extension display in or out of the cellular.

### TECHNICAL FIELD

The present invention generally relates to a portable communication device, and especially to a portable communication device with an external or built-in extension display.

### DESCRIPTION OF THE RELATED ART

In pace with the development of information and computer technology, electronic products grow rapidly in trend of small size, multifunction and high speed operation. Based on incoming of era of high technology, telecommunication network and internet becomes a novel industry currently, and in pace with the development of mobile phone integration technology, communication systems have also been introduced to provide users to obtain information more conveniently. Thus, the communication technology becomes an important role in the industry, and business accompanied with the communication device flourish due to the requirements of communication and the convenience of obtaining information. Internet, mobile communication devices, and PDA (personal digital assistant) have filled the whole space of life. And the internet and communication providers also provide business services to assist clients to transfer information or to extend the market and the coverage of services. And electronic components develop towards multifunction, such as small size, multifunction, and high speed. Communication services providers or information services providers also have to provide diverse, comprehensive and latest information to clients.

Signals received by the communication module are presented on the display after processed. Because the display of a conventional portable device is too small to be browsed, the present invention is introduced to overcome aforementioned difficulties.

### SUMMARY

The main purpose of the present invention is to provide a wireless communication device with a built-in or an external extension display to facilitate to browse webpage or image information.

A portable communication device with an extension display including: a control unit; a main display coupled to the control unit for displaying dial information to facilitate communication; and an extension display coupled to the control unit, wherein area of the extension display is greater than area of the main display, so as to display at least one part of webpage or image information. And the portable communication device further comprises a detecting module coupled to the control unit to facilitate to detect the webpage or image information. A switch device is coupled to the control unit to facilitate to transfer the webpage or image information to the extension display.

The extension display includes LCD (Liquid Crystal Display) or OLED (Organic Light Emitting Diode) display. Regarding a built-in extension display, it further comprises a storage device to store the extension display; regarding an external extension display, it further comprises an extension interface to couple to the extension display. And aforementioned extension display comprises a touch display.

### BRIEF DESCRIPTION OF THE DRAWINGS

FIG. 1 shows the function diagram of the present invention.

FIG. 2 shows the system of the present invention.

FIG. 3 shows the storage device of the present invention.

FIG. 4 shows the example of the present invention.

FIG. 5 shows the extension display of the present invention.

### DETAILED DESCRIPTION

The present invention can be applied to a wireless communication device, which includes, but is not limited to, a cell phone, a PDA (personal digital assistant), or a GPS (global positioning system). In general wireless communication systems, communication network service providers from different systems or regions use various communication protocols or two-way pager communication protocol, however, the present invention is not limited to any kinds of protocols.

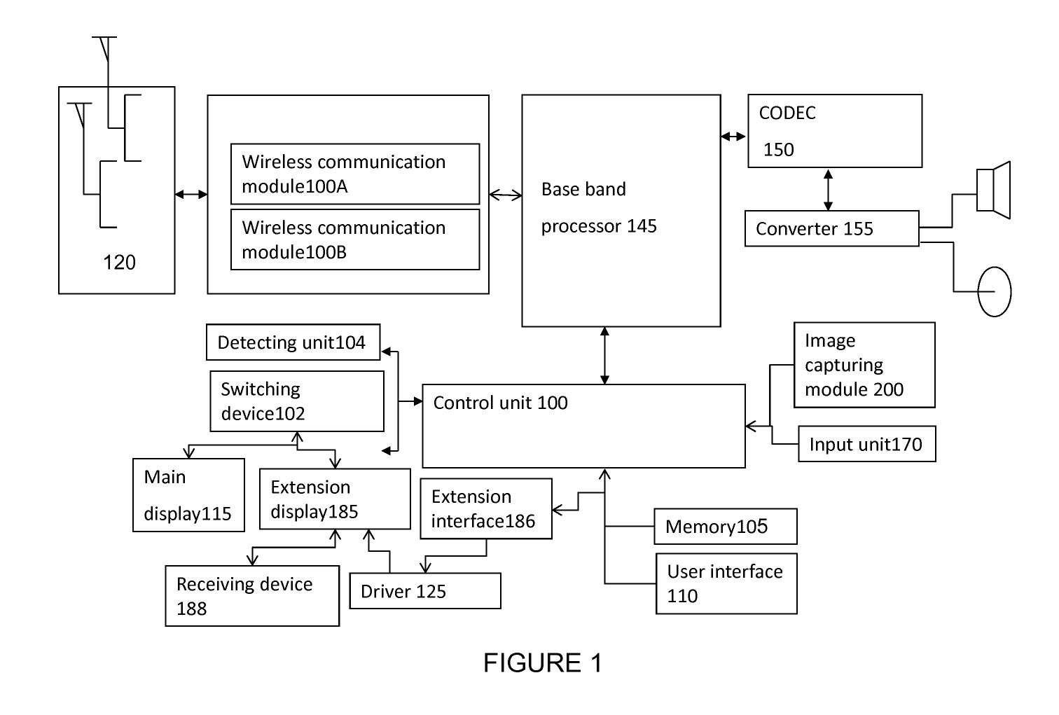

Referred to FIG. 1, which is a functional diagram of the wireless communication device of the present invention. For simplifying the specification, an embodiment is introduced hereinafter as an explanation, however, it's not used to limit the present invention, namely, the present invention can be modified to facilitate to use other different kinds of communication systems or protocols without departing from the spirit and scope of the present invention. For example, a single chip system can be introduced to integrate the chips or processors hereinafter. The portable communication device includes a control unit 100, such as a CPU, which is introduced to process or control the commands, information, data, and computing of the device. And a memory unit 105 which is coupled to the control unit 100 is, for example, ROM (read only memory), non-volatile memory such as flash memory and/or RAM (random access memory). Generally, permanent data can be stored in the ROM, and the system operation program or application programs can generally be stored in the non-volatile memory which can still retain the data stored in when power supply is unavailable and can be read or wrote repeatedly when power supply is available. The system operation program and application programs stored in the non-volatile memory control the execution of all necessary functions and can be presented on the main display 115 through the user interface 110 after processed by the CPU or the control unit. An input unit 170 is coupled to the control unit 100 to facilitate users to key in commands or data. The main display 115 is a screen of a general portable communication device, such as LCD or OLED display.

The antenna system 120 may be a multi-band antenna or composed by a plurality of antennas, according to demands. Aforementioned antenna may be dipole antenna, plane antenna, inverted-F Antenna, fractal antenna, etc. The antenna system 120 coupled to a wireless communication module 100A is introduced to receive signals, and the wireless communication module 100A which is suitable for transferring information in movement may generally include: converting signals to IF (intermediate frequency) through oscillator signals of mixing region of a receiver. The converted signals are modified to a bandwidth that the protocol predetermined by a transmitter, and transmitted by the antenna system. A modem is coupled to aforementioned receiver and transmitter to modulate or de-modulate signals. Aforementioned protocol can be an audio/video wireless communication protocol, which may includes, but is not limited to, International Telecommunications Unit (ITU): 3G, 3.5G, 4G, W-CDMA, CDMA2000, CDMA2001, TD-CDMA/TD-SCDMA, UWC-136, DECT. A base band processor 145 which may process the signals with predetermined bandwidth and aforementioned communication protocols is coupled to the modem of aforementioned wireless communication module 100A. A second wireless communication module 100B may be introduced, which may includes, but is not limited to, WiFi, Wimax, or 802.11x(a, b, g, n), and the second communication module 100B can exist individually or together with the wireless communication module 100A. Signals processed by the base band processor include control signals and audio signals, wherein the control signals are transmitted to the control unit 100 to be processed, and the audio signals are transmitted to a CODEC 150 to be processed. And a voice converter 155 is coupled to the CODEC 150 to convert the digital signals to analog signals or convert analog signals to digital signals. A microphone 160 and a speaker 165 are coupled to aforementioned voice converter 155 respectively. A SIM card connector (not shown in the figure) is introduced to facilitate a SIM card of the system to be inserted. The SIM card can be connected to the control unit 100 through the SIM card connector such that information and password stored in the SIM card can be accessed by the control unit 100. Besides, the present invention may also include a digital image capture module 200 connected to the control unit 100 to facilitate to transfer images, which may be a CMOS image sensor or CCD array. The captured images are transmitted to the control unit 100 to be processed.

Main display of conventional portable communication device is too small to display the webpage, such that the user has to move the webpage continuously, thereby interfering the user. The present invention includes a detecting unit 104 which may detect whether internet is connected or not. IF an internet package or signal is detected or the browser is activated, activate a switch device 102 and transfer internet signal or all or part of the information to the extension display 185 to display all or part of the information, whereby facilitating to display the webpage information. Display area of aforementioned extension display 185 may be greater than the area of the main display, and the user can determine whether the display is switched. Regarding the built-in extension display, it may comprise a receiving device 188 to receive the extension display 185. Take a flexible display as an example, such as OLED display, it can be rolled and received in a storage space, and can be drawn back to spread out the display. Aforementioned OLED (Organic Light-Emitting Diode) is also called OLED (Organic Electroluminesence Display). Advantages of OLED include luminescence, wide view angle, high contrast, low power consumption, high response speed, full color, simplified manufacturing process, etc. The species of OLED display comprise single-color type, multi-color type, and full-color type, etc. OLED displays can be classified as PMOLED (passive matrix OLED) and AMOLED (active matrix OLED) according to the differences of driven means. PLED (polymer light emitting diode) may also be introduced. Folding mechanism can be introduced to the present invention to facilitate the object of the present invention, and the receiving device 188 is a folding device at this embodiment. When the detecting unit 104 detects that the folding device is under operation, then the internet signals or all or part of information is transferred to the extension display 185 for extension display. The flexible display 300 can be fixed after it is extended. The flexible display 300 may be flexible OLED rolled around the reel 305. For receiving the flexible display, just release it after pulling hard, and then it will be rolled up. Generally, the reel 305 includes a spring 310 rolled around a central fixed stick 306 which is configured in the reel 305. Tighten the flexible display 300 which is spread out, and then a locking mechanism 315, such as ratchet 315 and detent 315a, can be introduced to prevent the spring 310 from being loosen when the flexible display 300 is extended. But, the ratchet 315 will not clamp when the flexible display 300 is pulled suddenly, thereby loosening the spring 310, such that the flexible display 300 will be rolled up. The technique of a plurality of displays for displaying images can be referred to ROC patent “personal computer system with multi-screens, Patent Number 468133”.

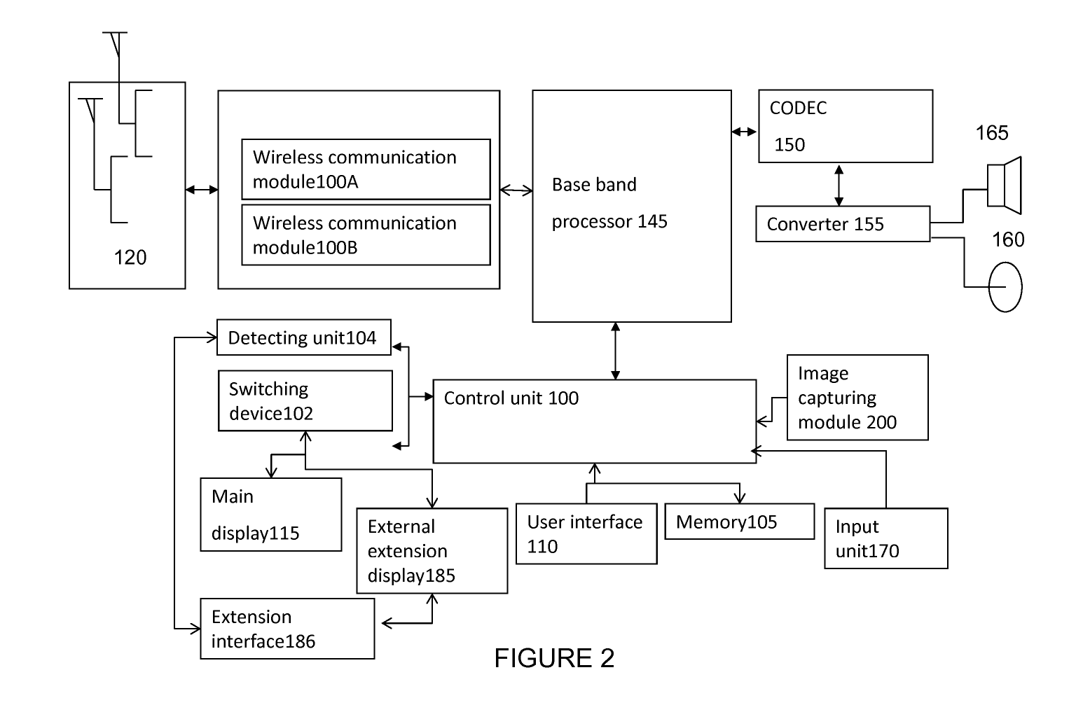

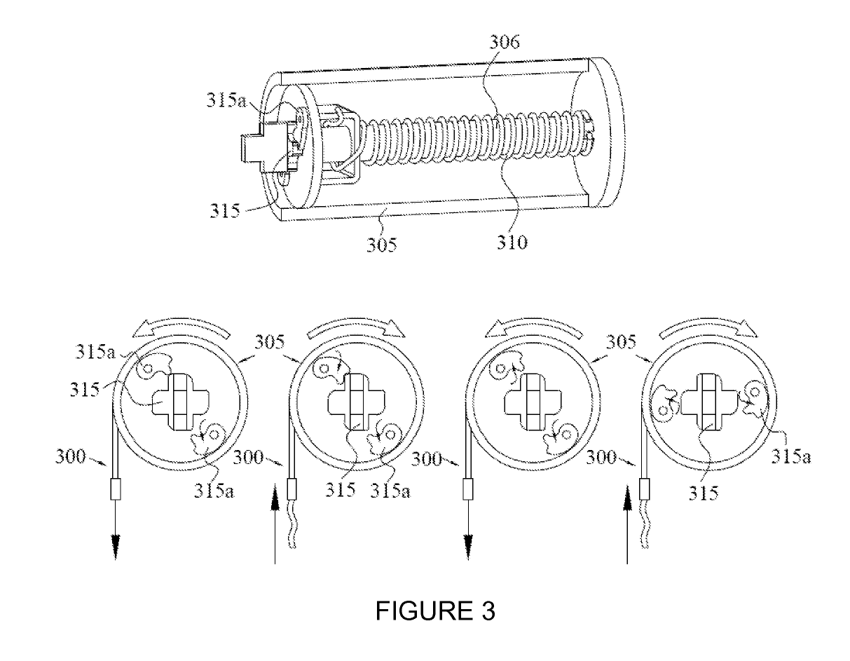

Regarding an external extension display, an external extension interface 186 is introduced, referred to FIG. 2. When the detecting unit 104 detects an external signal, transfer a switching signal to the switch device 102, so as to transfer the internet signals or all or part of information to the external extension display 185 to be displayed, which facilitates webpage information to be displayed. Aforementioned “switching” can be achieved manually or automatically by the software. Aforementioned detecting unit 104 which can be a single circuit or an integrated circuit may obtain parameters directly or indirectly.

Messages received by the communication device of the present invention can transfer all or part of webpage information manually or automatically to the extension display 185 by the switch device 102 to facilitate webpage to be browsed.

Other embodiments are most similar to aforementioned embodiments, and the difference is described as follows. When the detecting unit 104 detects video or dynamic, static image signals, such as video format, photo format, digital TV signals or MPEG signals, activate the switch device 102 to switch video signals to the extension display 185. For example, a commercialized processor which can process and decode the compressed MPEG file may be introduced, such as a media player chip having H.264 codec engine. For example, the processing chip is composed by a CPU core, a media engine, a graphics processor, and a virtual mobile engine (VME). The CPU core is based on the design of R4000 of MIPS, and comprises a floating point processor (FPU) and a vector floating point processor (VFPU), such that the ability of floating point computing can reach more than 2.6GFlops per second; the media engine can use R4000 which is an identical one used in the CPU core, and includes an independent embedded 2MB memory to assist the system to process audio/video stream. Thus, an embedded memory which can control the process of processing information by programming is introduced to adapt to the vector process unit including H.264 decompression, and various process demands such as audio process. And the utilization rate of the process unit may be improved by design of altering information process dynamically, thereby simplifying design of the chip and reducing lost of power. Software can also be introduced to decode or process.

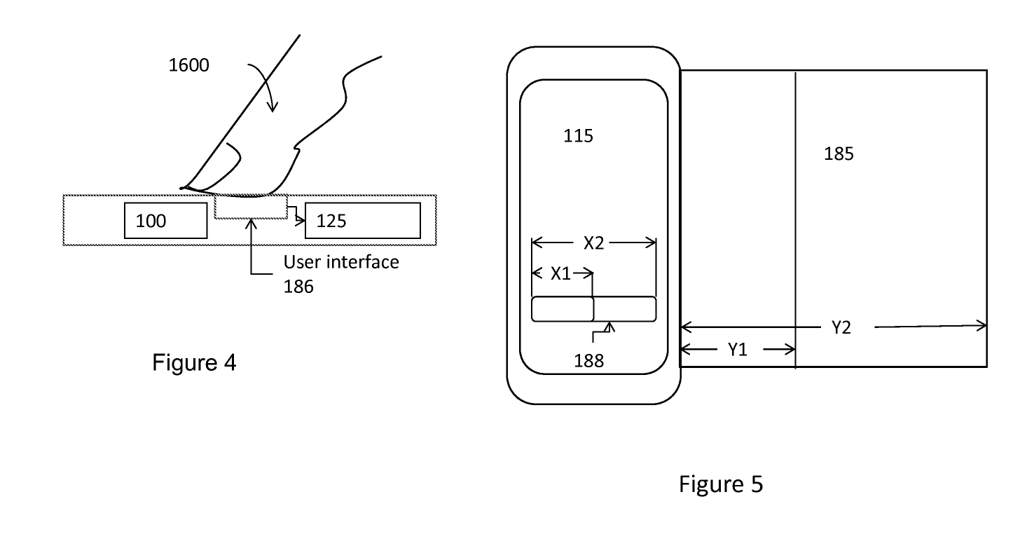

In another embodiment, the present invention provides an extension interface 186 displayed on the touch display, please refer to FIGS. 4 and 5. The extension interface 186 includes a slide bar 188 which can be arranged in horizontal, vertical or oblique orientation. In FIG. 5, a horizontal slide bar 188 is illustrated for an example. When the finger 1600 of the user touches the extension interface 186 on the touch display 115, the control unit sense the touch even, then it will initiate the instruct to the driver 125 for driving extension display 185 out of the cellular. The driver includes but not limited to a servo driver, a steeper driver or a MEMS driver. It is a small three-phase axial flux brushless dc (BLDC) motor. The stator is developed following the almost-standard CMOS technology rules used for MEMS manufacturing, and the coils have two copper layers. The rotor is made of a ring permanent magnet assembled over the stator chip. One of the articles may refer to “Development of a Hybrid MEMS BLDC Micromotor”, Published in: Industry Applications, IEEE Transactions on (Volume: 47, page 3-11). After the driver received the instruction, it drivers the extension display 185 out of the cellular with a proportion. For example, if the length of the slide bar 188 is X2, the length (wide) of the extension display is Y2, and the slide length of the finger is X1; then the extension length Y1 of the extension display is Y1/Y2=X1/X2; Y1=(X1)×(Y2)/X2. Therefore, the user may control the extension length proportion by controlling the slide bar 188.

A cellular with an extension display includes a control unit; a main touch display coupled to the control unit for displaying dialing information to facilitate communication; an extension display coupled to the control unit; an extension display interface having an extension slide bar displayed on the main touch display; a driver is in responsive to the extension display interface to driver the extension display out of the cellular, wherein a finger of a user slide the extension slide bar on the main touch display, the driver being responsive the sliding to drive the extension display in or out of the cellular; wherein the extension length of the extension display is equal to (the slide length of the finger)×(a length or wide of the extension display)/a length of the slide bar. The extension display is flexible. A detecting module is coupled to the control unit to facilitate to detect the webpage, video or image information. A switch device is coupled to the control unit to facilitate to transfer the webpage, video or image information to the extension display. The extension display includes a PLED (Polymer Light Emitting Diode) display, or an OLED (Organic Light Emitting Diode) display.

Aforementioned units and modules can be combined arbitrarily according to demands. As will be understood by persons skilled in the art, the foregoing preferred embodiment of the present invention is illustrative of the present invention rather than limiting the present invention. Having described the invention in connection with a preferred embodiment, modification will now suggest itself to those skilled in the art. Thus, the invention is not to be limited to this embodiment, but rather the invention is intended to cover various modifications and similar arrangements included within the spirit and scope of the appended claims, the scope of which should be accorded the broadest interpretation so as to encompass all such modifications and similar structures. While the preferred embodiment of the invention has been illustrated and described, it will be appreciated that various changes can be made therein without departing from the spirit and scope of the invention.

What is claimed is:

1. A cellular with an extension display including:
a control unit;
a main touch display coupled to said control unit for displaying dialing information to facilitate communication;
an extension display coupled to said control unit;
an extension display interface having an extension slide bar displayed on said main touch display;
a driver is in responsive to said extension display interface to driver said extension display out of said cellular, wherein a finger of a user slide said extension slide bar on said main touch display, said driver being responsive said sliding to drive said extension display in or out of said cellular.

2. The cellular according to claim 1, wherein said extension display is flexible.

3. The cellular according to claim 1, further comprises a detecting module coupled to said control unit to facilitate to detect said webpage, video or image information.

4. The cellular according to claim 1, further comprises a switch device coupled to said control unit to facilitate to transfer said webpage, video or image information to said extension display.

5. The cellular e according to claim 1, wherein said extension display includes a PLED (Polymer Light Emitting Diode) display, or an OLED (Organic Light Emitting Diode) display.

6. The cellular according to claim 1, further comprises a receiving device for receiving said extension display.

7. The cellular according to claim 6, wherein said receiving device is roller-type.

8. The cellular according to claim 1, wherein said extension display comprises a touch display.

9. The cellular according to claim 1, wherein an extension length is proportion to the slide length of said finger.

10. The cellular according to claim 1, wherein said extension length of said extension display is equal to (said slide length of said finger)×(a length or wide of said extension display)/a length of said slide bar.

11. A cellular with an extension display including:
a control unit;
a main touch display coupled to said control unit for displaying dialing information to facilitate communication; and
an extension display coupled to said control unit;
an extension display interface having an extension slide bar displayed on said main touch display;
a driver is in responsive to said extension display interface to driver said extension display out of said cellular, wherein a finger of a user slide said extension slide bar on said main touch display, said driver being responsive said sliding to drive said extension display in or out of said cellular; wherein said extension length of said extension display is equal to (said slide length of said finger)×(a length or wide of said extension display)/a length of said slide bar.

12. The cellular according to claim 11, wherein said extension display is flexible.

13. The cellular according to claim 11, further comprises a detecting module coupled to said control unit to facilitate to detect said webpage, video or image information.

14. The cellular according to claim 11, further comprises a switch device coupled to said control unit to facilitate to transfer said webpage, video or image information to said extension display.

15. The cellular e according to claim 11, wherein said extension display includes a PLED (Polymer Light Emitting Diode) display, or an OLED (Organic Light Emitting Diode) display.

16. The cellular according to claim 11, further comprises a receiving device for receiving said extension display.

17. The cellular according to claim 16, wherein said receiving device is roller-type.

18. The cellular according to claim 11, further comprises a receiving device for storing said extension display.

19. The cellular according to claim 11, wherein said extension display comprises a touch display.
